(19) United States
(12) Patent Application Publication
(10) Pub. No.: US 2015/0271162 A1
(43) Pub. Date: Sep. 24, 2015

(54) SYSTEMS AND METHODS FOR CONTROLLING SENSITIVE APPLICATIONS

(71) Applicant: Cyber-Ark Software Ltd., Petach-Tikva (IL)

(72) Inventors: Andrey Dulkin, Herzlia (IL); Erez Breiman, Tel-Aviv (IL); Yair Sade, Herzlia (IL)

(73) Assignee: Cyber-Ark Software Ltd., Petach-Tikva (IL)

(21) Appl. No.: 14/217,649

(22) Filed: Mar. 18, 2014

(51) Int. Cl. H04L 29/06

(52) U.S. Cl. CPC H04L 63/08; H04L 63/1408

(57) ABSTRACT

A method and system is provided for controlling a remote target application, including sensitive and privileged applications, via a remote application connection. The target application is executed with a set of credentials, different than those credentials submitted by the user to access the target application. The user, via a local client terminal, accesses the target application over the remote application connection, such that the user experience of interaction with the target application is similar to that of the target application running locally, while the target application is actually being run remotely. The execution is protected by the second set of credentials unknown to the user, thus preventing credential hijacking and various other threats to the sensitive application.

### BACKGROUND

The present invention, in some embodiments thereof, relates to controlling applications, and, more specifically, but not exclusively, to systems and methods for controlling applications with privileged access.

Every modern organization has multiple applications in its network, some of which are deemed sensitive, which are only accessible through privileged accounts, which require corresponding privileged or high-level credentials for access. The applications are deemed to be sensitive, due to the impact that the application has on the organization, for example, on its security, finances, resource management, customers and customer relations management, privacy, and other operations. Moreover, an organization may consider an application sensitive specifically when used with a specific user account, accounts such as personal, shared, role-related, privileged, since these accounts enables specific actions, hold permissions not available to other application users and their accounts.

These sensitive applications are accessed used from the user endpoint through a client. The client may be a web browser, which links to a server. The sensitive applications can also be installed applications, which communicate with other resources, as well as scripts, which operate locally or remotely in the network.

Management of sensitive applications presents many unique challenges. For example, the privileged credentials required to access these sensitive applications must be well protected, so as not to be accessible to unintended users. Such an unintended user, with these privileged credentials, can impersonate a legitimate user, with whom the credentials are associated, and severely compromise the organization's computer system, as well as committing malicious or dangerous acts, with potentially catastrophic consequences.

Another security concern with sensitive applications is that the users themselves are aware of and in possession of the credentials needed to access the sensitive application. If this user is not protected, the credentials can be hijacked and abused. For example, an attacker can use software that captures keystrokes and hijacks username/password combinations. Another example potential route of attack is for the attacker to extract credentials, such as access keys or credentials files, from the client applications and use them to gain access to the target system.

There are also difficulties associated with granting and denying access to the target application, e.g., the sensitive application, due to the client providing the credentials, which both he and the system supporting the target application must be aware of. This is especially true when passwords are changed, in accordance with organizational rules, or changes at the user's request, with the password changes having to be accounted for by the system supporting the target application.

Additionally, by having only one password between the client and the target application, security of the sensitive application is limited. This is because with human clients, passwords are typically of limited complexity, as they must be remembered by a human. Passwords of limited complexity are also relatively easy for computer programs to determine. Moreover, humans tend to use the same password for multiple applications, machines, devices and the like, as it is easy to remember, compared to different passwords for each of the user's applications, machines and devices. As a result, should a password for the particular user be found, there is a good possibility that an imposter may applied the password successfully in multiple applications, machines and devices associated with the user, causing substantial damage to an organization's computer system.

Another security concern involves managing shared credentials, a situation where multiple users in an organization use the same credentials to access a sensitive application. For example, when using a Windows® network, multiple users may use a shared account under the name Domain Administrator. Accordingly, there is no indication of who the specific user is, which prevents accountability for performed actions of the sensitive application. This increases the chances for a security breach of the organization's computer systems. Moreover, should there be a security breach of the organization's computer systems, it may be difficult to identify the source of the breach, due to the multiple actual network administrators, all using the same share account.

Maintaining the security of a sensitive application is even more challenging when the application is distributed or located in multiple locations. By being in multiple locations, there may be different security levels at each location, such that the application is exposed threats such as to unauthorized use, credentials misuse, and unmonitored activity, even by legitimate and authorized users.

One system for handling sensitive applications, presently in use, includes the use of terminal servers, such as Citrix® XenApp® or Microsoft® Remote Desktop Services. These terminal servers, serve as intermediaries between clients ant the target, e.g., the sensitive application. These terminal servers support two separate and distinct connections, a first connection, where the user logs into an account of the terminal server, and a second connection, between the terminal server and the target system, with a different account. This results in two separate sessions, with the terminal server, or intermediary forwarding the information between the two separate sessions. For example, the first session, between the client and the intermediary, provides features such as interaction capabilities, forwarding keystrokes, mouse movement and returning screen images, while the second session, between the intermediary and the target system, is the actual connection to the sensitive application. By having two separate sessions, the original application “look-and-feel” is lost, and the user experience has changed significantly, as the user does not experience the application as a local application, but rather, as a remote application, at a network node over the network, beyond his endpoint.

### SUMMARY

According to an aspect of some embodiments of the present invention there is provided a computer-implemented method performed by a computer system for controlling use of applications, accessible via a network. The method comprises: receiving, by a credentialing system, a first set of user credentials from a client terminal at a first network node, via the network, for requesting access to a target application, the target application hosted and controlled by a computer system at a different network node; receiving, by the computer system, over the network, a request to initiate a remote application connection to the target application; providing, by the credentialing system, to the computer system, a second set of application credentials, upon successful authentication of the first set of user credentials and the user, via the client terminal, being allowed access to the target application; executing the target application, by the computer system, using the second set of application credentials; and, connecting, by the computer system, the remote application connection initiated by the request to initiate the remote application connection, with the executing target application. At the first network node, the user experience of interaction with the target application is similar to that of a locally running application, as a desktop application of the client terminal connects via the remote application connection to the target application executing remotely at the computer system, and, the second set of application credentials are different from the first set of user credentials.

Optionally, the computer system includes a server which hosts the target application and at least one module for starting execution of the target application, the server at a second network node.

Optionally, the computer system includes a first server which hosts the target application, at a second network node, and a second server which hosts at least one module for starting execution of the target application, the second server at a third network node.

Optionally, the execution of the target application includes a starting module of the computer system executing the target application.

Optionally, the starting module executes the target application using the second set of credentials.

Optionally, the starting module executes the target application and passes the second set of credentials to the target application.

Optionally, the target application is associated with a network resource linked to the network.

Optionally, the connecting of the remote application connection begins a target application session, and the method additionally comprises: monitoring the target application session by monitoring at least one of: the target application, the network resource associated therewith, the system hosting the target application, the communications network of the enterprise associated with the target application, and the communications network of the enterprise associated with the network resource associated with the target application.

Optionally, the monitoring is at least one of: video monitoring, real-time monitoring, over the shoulder monitoring, and command level auditing.

Optionally, the monitoring includes detecting hazards to at least one of, the target application, the network resource associated therewith, the system hosting the target application, the communications network of the enterprise associated with the target application, and the communications network of the enterprise associated with the network resource associated with the target application.

Optionally, an interference action is taken in response to at least one of the hazards being detected.

Optionally, the interference action is at least one of: sending limiting commands to the target application, terminating the remote application connection, and closing the target application.

Optionally, an interference action is taken in response to at least one external trigger.

Optionally, the interference action is selected from the group consisting of sending limiting commands to the target application, terminating the remote application connection, and closing the target application.

Optionally, the second set of application credentials does not pass through the first network node.

Optionally, the connecting, by the computer system, of the remote application connection with the executing target application is performed automatically.

According to an aspect of some embodiments of the present invention there is provided a computerized system for controlling use of applications, accessible via a network. The system comprises: a credentialing system in communication with the computer system, the credentialing system for receiving a first set of user credentials from a client terminal at a first network node, via the network, for requesting access to a target application, and issuing a second set of application credentials to a computer system which hosts and controls the target application; a computer system at a different network node, including: a) a target application which is hosted and controlled by the computer system, and, b) a starting module for receiving application credentials from a client terminal, connecting a remote application connection between the client terminal and the target application, and executing of the target application using the second set of application credentials; and, a triggering module associated with the client terminal at the first network node, the triggering module for issuing requests to the computer system to initiate remote application connections to the target application. At the first network node, the user experience of interaction with the target application is similar to that of a locally running application, as a desktop application of the client terminal connects via the remote application connection to the target application executing remotely at the computer system, and, wherein the second set of application credentials are different from the first set of user credentials.

Optionally, the computer system includes a server which hosts the target application and the starting module, the server at a second network node.

Optionally, the computer system includes a first server which hosts the target application, at a second network node, and a second server which hosts the starting module, the second server at a third network node.

Optionally, the starting module additionally passes the second set of credentials to the target application after executing the target application.

Optionally, the target application is associated with a network resource linked to the network.

Optionally, the computer system additionally comprises a monitoring module for monitoring at least one of: the target application, the network resource associated therewith, the system hosting the target application, the communications network of the enterprise associated with the target application, and the communications network of the enterprise associated with the network resource associated with the target application.

Optionally, the monitoring module is constructed and arranged for performing monitoring by at least one of, video monitoring, real-time monitoring, over the shoulder monitoring, and command level auditing.

Optionally, the monitoring module is constructed and arranged for detecting hazards to at least one of, the target application, the network resource associated therewith, the system hosting the target application, the communications network of the enterprise associated with the target application, and the communications network of the enterprise associated with the network resource associated with the target application.

Optionally, the computer system additionally comprises an interference module constructed and arranged for taking an interference action in response to at least one of the hazards being detected, the interference actions is selected from the group consisting of sending limiting commands to the target application, terminating the remote application connection, and closing the target application.

Optionally, the computerized system additionally comprises an external trigger linked to the network for communicating with the interference module for activating the interference module to take the interference action.

According to an aspect of some embodiments of the present invention there is provided a computer-usable non-transitory storage medium having a computer program embodied thereon for causing a suitable programmed system for controlling use of applications, accessible via a network, by performing the following steps when such program is executed on the system. The steps comprise: receiving a request to initiate a remote application connection to a target application, the target application hosted and controlled by a computer system at a first network node; receiving from a credentialing system, a set of application credentials, upon the credentialing system having authenticated a set of user credentials, sent from the user, via the client terminal at a second network node different than the first network node, to the credentialing system; providing the user, via the client terminal access to the target application; and, executing the target application using the set of application credentials; connecting the remote application connection initiated by the request to initiate the remote application connection, with the executing target application. At the second network node, the user experience of interaction with the target application is similar to that of a locally running application, as a desktop application of the client terminal connects via the remote application connection to the target application executing remotely at the computer system, and, the set of application credentials are different from the set of user credentials.

Optionally, the step of connecting of the remote application connection begins a target application session, and the steps additionally comprise: monitoring the target application session by monitoring at least one of: the target application, the network resource associated therewith, the system hosting the target application, the communications network of the enterprise associated with the target application, and the communications network of the enterprise associated with the network resource associated with the target application.

Optionally, the monitoring is at least one of: video monitoring, real-time monitoring, over the shoulder monitoring, and command level auditing.

Optionally, the monitoring includes detecting hazards to at least one of, the target application, the network resource associated therewith, the system hosting the target application, the communications network of the enterprise associated with the target application, and the communications network of the enterprise associated with the network resource associated with the target application.

Optionally, additional steps comprise: taking an interference action in response to at least one of the hazards being detected.

Optionally, the interference action is at least one of sending limiting commands to the target application, terminating the remote application connection, and closing the target application.

Optionally, the steps additionally comprise: taking an interference action in response to at least one external trigger.

Optionally, the interference action includes at least one of sending limiting commands to the target application, terminating the remote application connection, and closing the target application.

Throughout this document, a “remote application” refers to an application that runs on a separate machine, while retaining the user experience of a local application running on the user machine. There are several products available which provide this functionality, including, for example, Microsoft® RemoteApp, Citrix XenApp and VMware ThinApp.

Throughout this document, references to the “user experience of interaction with a target application, is similar to that of a locally running application,” generally implies that the user can easily switch between windows of the application and those of other locally-running applications. Other application interactions include, for example, moving and resizing of the application window, having the window appear in the user's taskbar with the original application icon and name (where relevant), providing keyboard, mouse and other input (as configured and applicable) and the like. The aforementioned features depend on the OS (operating system) capabilities and other limitations as enforced by the organization. However, overall the user experiences their interaction with the application as if they were interacting with a local application.

Throughout this document, a “remote application connection” refers to a connection, link or pipe between an endpoint on a network and a server, machine or the like that hosts the remote application, which places the end point and the machine in electronic and/or data communication, to access the executing remote application.

Throughout this document, a “machine” refers to an execution environment, for example, for computer software, programs and the like, including a physical or virtual hardware environment and an operating system. Examples of “machines” include computers and computing or computer systems (for example, physically separate locations or devices), servers, computer and computerized devices, processors, processing systems, computing cores (for example, shared devices), and similar systems, modules and combinations of the aforementioned.

Throughout this document, a “target application” includes and is representative of applications, for example, a “sensitive application” or a “privileged application.” The sensitive and privileged applications are hosted or otherwise defined in a machine or system, which holds high operation permissions, and include any application where privileges are defined under one or more rules. A “sensitive application” or a “privileged application” may be a shared application. An application can be deemed sensitive if it uses a “sensitive” or “privileged” account—for example, a remote access application such as PuTTY (PuTTY is an open-source terminal emulator, serial console and network file transfer application, which implements the client end of that remote session: the end at which the session is displayed, rather than the end at which it runs) can be non-sensitive by itself, but if it is used to access remote machines with the “root” or “system administrator” account it will be deemed sensitive. The terms “target account,” “sensitive account,” and “privileged account” are used interchangeably in this document.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a diagram of an exemplary environment including the control system in accordance with some embodiments of the present invention;

FIGS. 2A, 2B and 2C form a flow diagram of a process in accordance with some embodiments of the present invention; and

FIG. 3 is a diagram of another exemplary environment including the control system in accordance with some embodiments of the present invention.

### DETAILED DESCRIPTION OF THE DISCLOSED EMBODIMENTS

Some embodiments of the present invention are directed to methods and systems for controlling remote target applications, including sensitive and privileged applications, via a remote application connection, which is made based on the approval of credentials, different than those credentials submitted by the user to access the target application. With the sets of credentials approved, a remote application connection between a user computer, also known as a client terminal, at one node or endpoint of the network and the target application, hosted at a different node or endpoint on the network, is connected. The target application is run remotely by the user, for example, from a desktop application to the target application, over the remote application connection. This connection from the desktop application of the client terminal to the target application running on a remote computer creates a user experience with the target application, which mimics that of the target application running locally, when in actuality, the target application is actually being run remotely. This operation of embodiments of the present invention is in contrast to that of remote desktop protocol (RDP) applications, where a user controlled desktop for a computer is used to control another remote desktop for another computer, this other computer for executing a target application.

Some embodiments of the present invention are directed to credentialing systems which utilize a separate set of credentials for accessing and running target applications on a system. This separate set of credentials is different from the set of credentials which the user sends to the credentialing system to access the target application. This separate set of credentials is not known by, or divulged to, the user. Rather, this separate set of credentials is known only to the credentialing system, and this separate set of credentials is used for accessing the system on which the target application runs.

In some embodiments of the present invention, the client's request is not sent directly to the target system on which runs the target application, but rather, goes through a proxy system. This proxy system performs an authentication on the client and the request from the client for the target application. The proxy system also enforces the access policies, which cover, for example, the permitted time, source, destination and protocols for the connection, and also records the target application usage system and monitors the target application in real time. The proxy system provides the required security credentials to the system running the target application.

Some embodiments of the present invention negate the need for the client's possession of the shared or privileged credentials, thus preventing an attacker or malicious user from hijacking and abusing them.

Some embodiments of the present invention allow for the use of complex and unique passwords. These complex and unique passwords are passed between the credentialing system, and may also be used with a proxy system, which authenticates credentials, and the target system, which runs the target application, for example, a sensitive or otherwise privileged application. As these system or application passwords are not provided to the user, e.g., via the client, they are never known to the user and accordingly there is no need for the user to remember them. As a result, the passwords and credentials can be changed as often as required, as only the target system and the credentialing system need to be aware of the new, changed credentials.

Some embodiments of the present invention can be applied to a wide range of applications without requiring workflow changes or any specific design or added features of the controlled application. This is because of a credentialing system, which serves as an intermediary between the user at the corresponding client terminal and the machine which hosts and controls the target application. The credentialing system utilizes separate and different sets of credentials in communications between 1) the client terminal and the credentialing system; and, 2) the credentialing system and the machine which hosts and controls the target application.

Some embodiments of the present invention achieve control over target applications by controlling the credentials, managed by a credential management (or credentialing) system, which serves as an intermediary between the client and the target application, hosted on a secure server.

Some embodiments of the invention retain workflows and maintain the user experience. This is because users of target applications typically expect a certain user experience and workflow, such as applications for providing a user interface which emulates a locally running application, with additional security features, such as separate credentials, different from those entered by the user to actually run the sensitive and/or privileged applications, as well as the target application being controlled at a remote secure server. This is instead of, for example, a remote desktop protocol (RDP) application, which is accessed and run on a single set of credentials and the application is at a remote desktop, this remote desktop being controlled locally by the user through his local desktop. When the workflow or user experience differs from that which is known or established, the adoption of a new deployment may be inhibited and even rejected, despite the benefits it offers in security aspects.

Embodiments of the present invention retain the established user experience and application look-and-feel. Upon acceptance of application credentials, provided by a credentialing system to a secure server, which runs and controls the sensitive and/or privileged application, the application credentials different from the user credentials, the user is connected with the target application, which is being run remotely on the secure server. Although the target application is being run and controlled remotely, the direct connection between the user and the remote target application makes the target application feel like it is being run locally. This single application experience is unlike regular RDP session, which presents the user with a remote desktop, from which a specific application is selected and run, which makes the user aware of the fact that they are working on a remote machine.

Some embodiments of the present invention allow for user actions to be monitored. This is due to the fact that the target application is hosted on a server, which can run additional modules, such as a monitoring module. Additionally, since the credentials for running the application are controlled by a credentials management system, no other instances of this privileged application can be created on other servers. The monitoring enables subsequent auditing of all connections and communications between clients and target application.

Additionally, embodiments of the present invention enable control over the establishment of sessions for the sensitive application and control over the sessions themselves. The disclosed system may limit the times when the connections can be established, determine the source (client), and destination (target) allowed for the connection, determine actions allowed and enforce other limitations in accordance with system and/or organizational rules and policies.

Some embodiments of the present invention facilitate accountability for sensitive application sessions when a shared account is used. The user authenticates to a credentialing system, using his personal identity. The credentialing system, directly or through a proxy system in turn, provides the target application with a shared account. The credentialing process, with separate sets of credentials for the user and the application, with the application credential set not known to the user, enables the system to link between the specific user identity used to access the credentialing system, and the actions performed with the shared or privileged identity. This provides accountability, linking performed privileged actions to a specific user.

Some embodiments of the invention also enable the system to interfere with actions performed through the target application. This interference includes termination of the target application session.

Some embodiments of the invention are such that the target application, running on the remote server, is operable with numerous presently existing systems. As a result, special adaptations, modifications and the like are not needed for use with the system and as such, legacy code and other applications associated with the target application remain protected.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s), which are non-transitory, may be utilized. The computer readable medium may be a non-transitory computer readable signal medium or a non-transitory computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

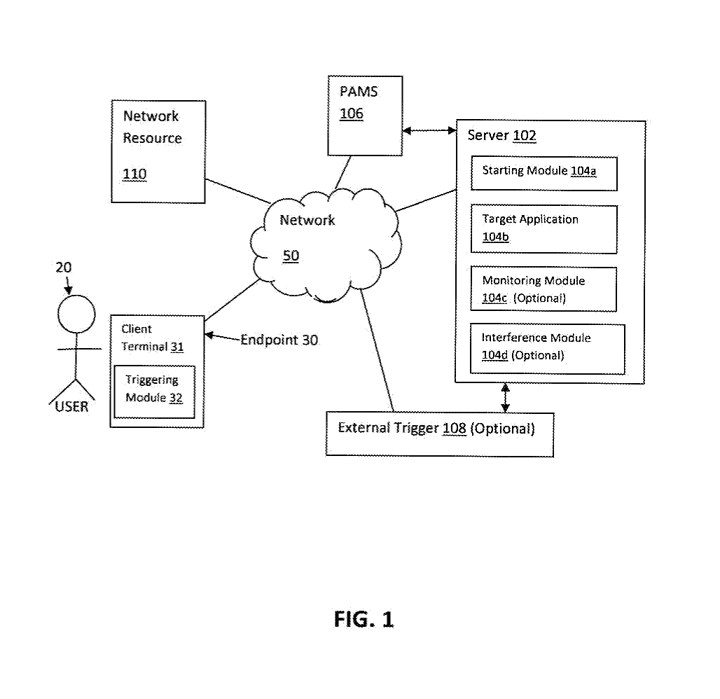

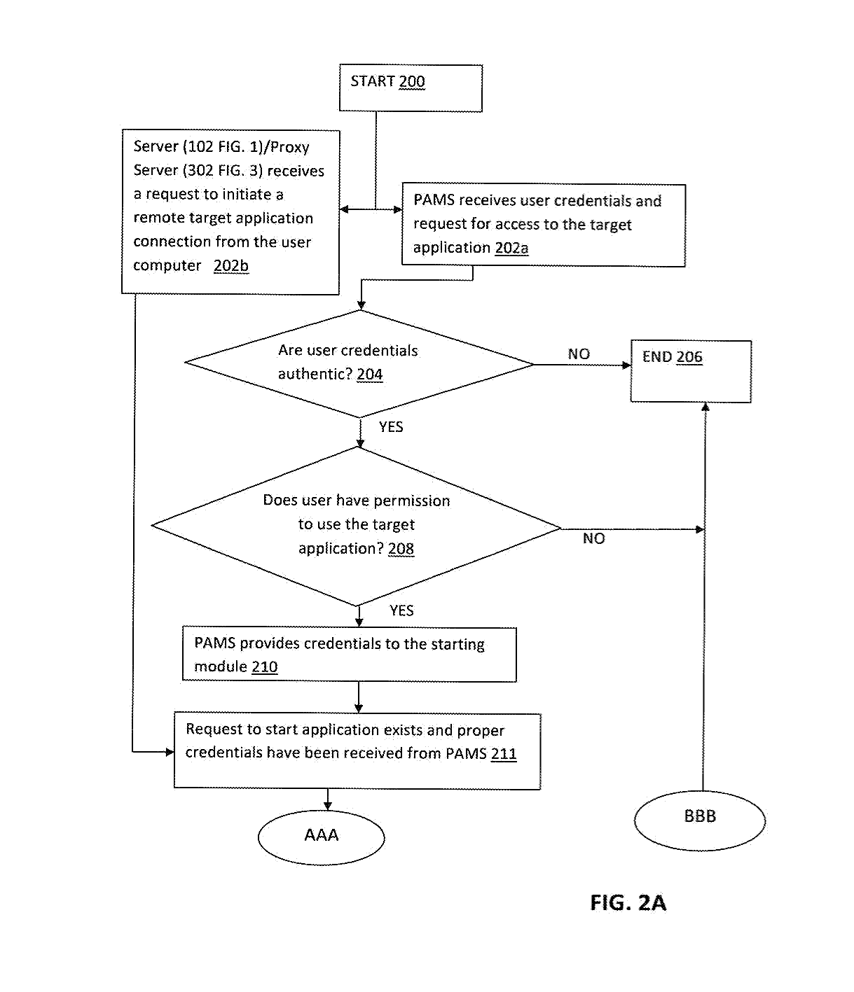

Reference is now made to FIG. 1, which shows an operating environment for a server 102, which defines a non-limiting exemplary control system, in accordance with some embodiments of the present invention. The server 102 is, for example, a secure server, in that it includes security features including the ability to respond to receiving credentials, different than those which the user submitted to access the target application, by executing a target application and connecting a remote application connection from a client terminal 31 to the target application 104b hosted by the server 102. This connected remote application connection provides users 20, via their client terminals 31, a user experience for the target application 104b simulating that of a local application. In actuality, the target application is being run and controlled remotely by the server 102. Additionally, the application credentials used to start execution of the target application and connect the remote application connection, are not exposed to the client terminals, from which a different set of user credentials is issued for the corresponding client terminal to the client to gain access to the target application.

The server 102 is shown linked over a network 50, either directly or indirectly. The server 102 is located at a network node or endpoint. The server 102 includes machines, and is formed of modules including a starting module 104a. The server 102 also hosts a target application 104b. The target application 104b, is representative of, for example, a sensitive application or a privileged application. The server 102 also includes an optional monitoring module 104c and an optional interference module 104d. The modules 104a, 104c, 104d and the target application 104b are linked to each other within the server 102.

The server 102 is designed to receive a set of credentials, known, for example, as “application credentials,” from a credentialing system, known as a Privileged Account Management System (PAMS) 106. This set of application credentials is unknown to the user 20 and different from the user's credentials, known, for example as “user credentials,” which the user 20 uses to authenticate to PAMS 106. The user 20 send the user credentials from a client terminal 31, which includes, for example, a computer of the user 20. The client terminal 31 serves as an endpoint 30 for the network 50. The client terminal 31 is representative of multiple client terminals linked to the network 50, at endpoints similar to that of the endpoint 30.

The client terminal 31 accesses the target application 104b via a remote application connection. For example, the user 20 accesses the target application 104b, when a triggering module 32, in or associated with the client terminal 31, initiates an authorized connection, known as a remote application connection, between the client terminal 31, i.e., the user's computer, at the endpoint 30 and the target application 104b hosted by the server 102, over the network 50. This connection will only be established when the starting module 104a completes its operation (see below). As a result of this arrangement, the user experiences the target application 104b as if it is hosted locally, when the target application 104b is actually hosted remotely over the network 50, by the server 102.

The server 102 of the control system includes the starting module 104a. The starting module 104a starts the target application 104a with the application credentials, received from PAMS 106, and opens the remote application connection to the target application 104b from the endpoint 30, over the network 50. The starting module 104a, for example, starts the target application 104b upon receiving a request to initiate a target application 104b connection from the triggering module 32, coupled with proper credentials having been received from PAMS 106, the credentialing system. The starting module 104a also optionally starts the monitoring module 104c, as detailed further below.

The aforementioned “application credentials” are only passed from PAMS 106 to the server 102. The “application credentials” are a completely separate and different set of credentials than the aforementioned “user credentials” which were sent from the client terminal 31 to PAMS 106, as detailed above. The application credentials do not pass to the endpoint 30 and are unknown to the user 20.

The server 102 is linked directly (shown by the double headed arrow) to PAMS 106, but may also be linked to PAMS via the network 50. The PAMS 106 is also linked to the network 50, and is located at a network node. The PAMS 106 functions as a credentials management system, also known as a “credentialing system,” as it stores and manages data for and usage of privileged accounts, such as credentials for accessing target applications, from both the user and for the control system. The PAMS 106 also serves to control access, for example, by credentials management, to other restricted access accounts.

The server 102 is, for example, a machine or system of machines and/or computers, or a computer system, implemented in a user-server configuration according to some embodiments of the present invention and addressable over a network 50, such as a Local Area Network (LAN), Wide Area Network (WAN), including public networks such as the Internet, using a client terminal 31 (or client) and display, represented by the endpoint 30, which links to the network 50. A user 20 at the endpoint 30, is representative of all users, both authorized and unauthorized for the target application 104b and the network resource 110. Other users 20 may be system administrators and the like, and are identified as such.

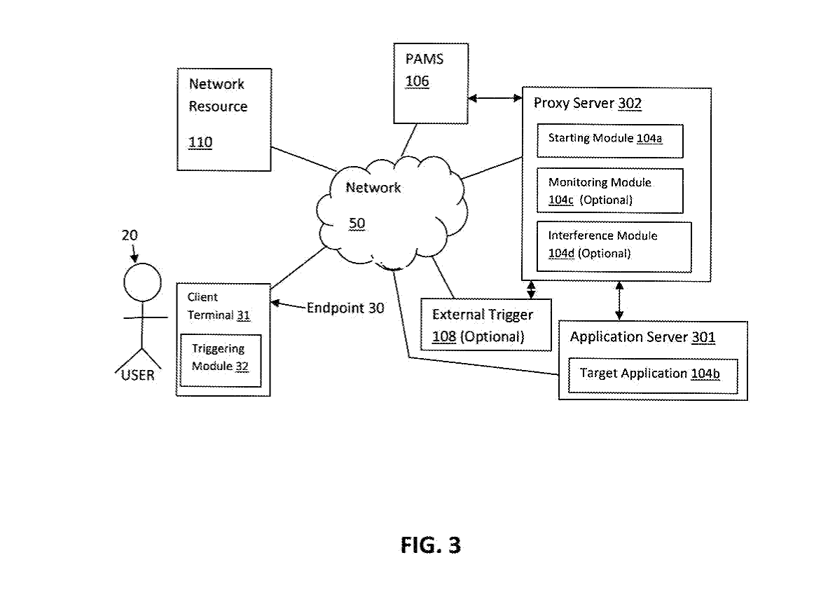

A triggering module 32 is at the endpoint 30, and is in or associated with the client terminal 31. The triggering module 32 links to the network 50. The triggering module 32 communicates, both electronically and with data, over the network 50, in separate connections with both the server 102 for the target application 104b, and PAMS 106, to provide user credentials, for the client terminal 31 at the endpoint 30 to access the target application 104b. The triggering module 32, either close in time or simultaneously, with sending the user credentials to PAMS 106, initiates or starts the remote application connection with the target application 104b of the server 102, from the endpoint 30. The initiation or starting typically involves the triggering module 32 sending a request to the starting module 104b, in the server 102 (FIG. 1), or the proxy server 302 (FIG. 3) to initiate a target application from the client terminal 31 (user computer). The starting module 104a establishes the aforementioned remote application connection between the client terminal 31, at the endpoint 30, and the target application 104b once the starting module 104a has received the initiation request and authenticated the application credentials received from PAMS 106. For retaining the local application user experience, the remote application connection may be provided by, for example, RemoteApp®, from Microsoft®.

While numerous components are detailed below, numerous servers, machines, devices, computer systems and the like may be linked, either directly or indirectly, to the network 50, for operation with the server 102.

An external trigger 108, which is an optional component, is also linked to the network and connected to the server 102. The external trigger 108 links to the interference module 104d, to activate it, upon the external trigger 108 detecting activity and/or conditions considered to be threats. This external trigger 108, is, for example, in accordance with the product disclosed in “Privileged Threat Analytics™,” available from CyberArk® Software Ltd. Petakh Tikva, Israel, the disclosure of which is incorporated by reference herein. This Privileged Threat Analytics™ product, collects information about the activity in the network, detects anomalous behavior, and alerts on potential security incidents. In this implementation, the external trigger 108 can signal the interference module 104d, to activate. An external trigger can also come from a human operator, such as a member of a CIRT (Computer Incident Response Team), who upon a detection of an anomaly in the network or according to some other logic, signals the interference module 104d.

A network resource 110, is representative of multiple network resources, and links either directly or indirectly to the network 50. The network resource 110 is located at a network node or endpoint, and maps back to the server102. The network resource 110 may also be directly connected to the server102. The network resource 110, for example, is typically a resource operated through access to the target application 104b. The terms “network resource” and “target resource” are used interchangeably, below. While the network resource 110 is shown as a single device or machine, it may be a plurality of devices or machines.

PAMS 106 is typically external with respect to the control system 100. PAMS 106 may be of singular or multiple components, as it may be formed of a plurality of computers, machines, devices, storage media, processors, devices, and other components, either directly connected to each other or linked together via the network 50. The PAMS 106 may be hardware, software, or combinations thereof.

The PAMS 106 is a system that, for example, manages privileged accounts, and other restricted access, associated with various network resources, for example target resources 110 linked to the network 50. The managed privileged accounts are administered by PAMS 106 in accordance with organizational rules and policies for each target resource, such as target resource 110. PAMS 106 manages, for example, user authentication, mapping of users to the target accounts 104b (for the specific resource) they are authorized to use, and logging the usage of the privileged accounts.

The PAMS 106 holds the credentials for target accounts and a mapping of users, for example, system administrators, permitted to access the target 104b accounts, according to respective organization-defined policies. An important aspect of PAMS 106 is the support of various workflows, for example managerial approval for password retrieval, correlation with ticketing systems, one-time passwords and password replacement. These aspects of PAMS 106 support organizational policies and procedures for network security and access control.

PAMS 106 administers two types of credentials, user credentials and application credentials. These two types of credentials are separate from each other, as user credentials are between the triggering module 32 of the client terminal 31 at the endpoint 30 and PAMS 106, while the application credentials are between the PAMS 106 and the starting module 104a of the server 102. The application credentials are not those of the user and are not known to the user. Moreover, the application credentials, as they are not known to the user and need not be rememberable by a human, as they are passed between PAMS 106 and the server 102 are passwords and other data of high complexity, extremely difficult to remember, hack or otherwise obtain.

PAMS 106 includes storage, or links to storage, for credential retrieval data. Credential retrieval data includes, for example, data indicative of historical credential retrieval actions, and other historical data. Credential retrieval data includes, for example, records for password or certificate requests, requests to perform actions associated with the target resource 110, activity logs of credentials requests and activities requested to be performed or performed which are associated with the target resource 110.

PAMS 106 is such that the target application user 20 authenticates to PAMS 106 with user credentials. PAMS 106 then provides the privileged credentials to the server 102, which runs the target application 104b, without the credentials ever passing through the endpoint 30 and without disclosing the privileged credentials to the user 20. The PAMS 106, may be, for example, a system commercially available as PIM (Privileged Identity Management)/PSM (Privileged Session Management) Suite, from CyberArk, www.cyberark.com, as modified to serve as a credentialing system, as detailed above.

Turning back to the server 102, both the monitoring module 104c and the interference module 104d are optional components. The monitoring module 104c is, for example, controlled by the starting module 104a. The monitoring module 104c enables various forms of monitoring, such as video monitoring, real-time monitoring, and command-level auditing. The monitoring can be programmed to analyze and detect threats and dangers to the remote application connection, the target application 104b, the system 100, the network resource 110, and enterprises communication network and machines associated therewith.

Video monitoring includes video recording of the sensitive application session and user's interaction with the application. This recording can later be used for auditing and accountability.

Real-time monitoring occurs when another user, manager or monitoring application monitors the sensitive application session, including the remote application connection, and a user's interaction with the sensitive application 104b in real-time. This real-time monitoring is also known as “over-the-shoulder monitoring.” Command-level auditing is another form of monitoring, which includes examining and analyzing specific commands for example, as unusual or abnormal, which are performed by the target application 104b, which may be considered as hazards, such as threats or dangers to the enterprise, its machines, network resources and/or its network. These commands are logged by the monitoring module 104c, and stored in the server 102 or elsewhere in locations associated with the server 102. The monitoring module 104c can be in communication with the interference module 104d. The monitoring module 104c can additionally be programmed to signal the interference module 104d, directly, i.e., internally, or indirectly, such as over the network 50, to take action, when the monitoring module 104c has detected a hazard, such as a threat or danger to the target application 104b, the server 102, the network resource 110, and enterprises communication network and machines associated therewith.

The interference module 104d enables various forms of interference, such as limitations enforced on the target application 104b according to a predefined logic. These enforcements include, for example, limitations on commands sent to the target application 104b, closing of the target application 104b, or terminating the connection to the target application 104b. These limitations can be enforced at various levels, for example, the target application level (such as sending a command to the application to prevent some functionality), the communication protocol level (such as preventing some user input from reaching the application), and the operating system or machine level (such as preventing the application from executing system calls or receiving the results of system calls). The interference module 104d can also function to terminate the remote application connection or close the target application.

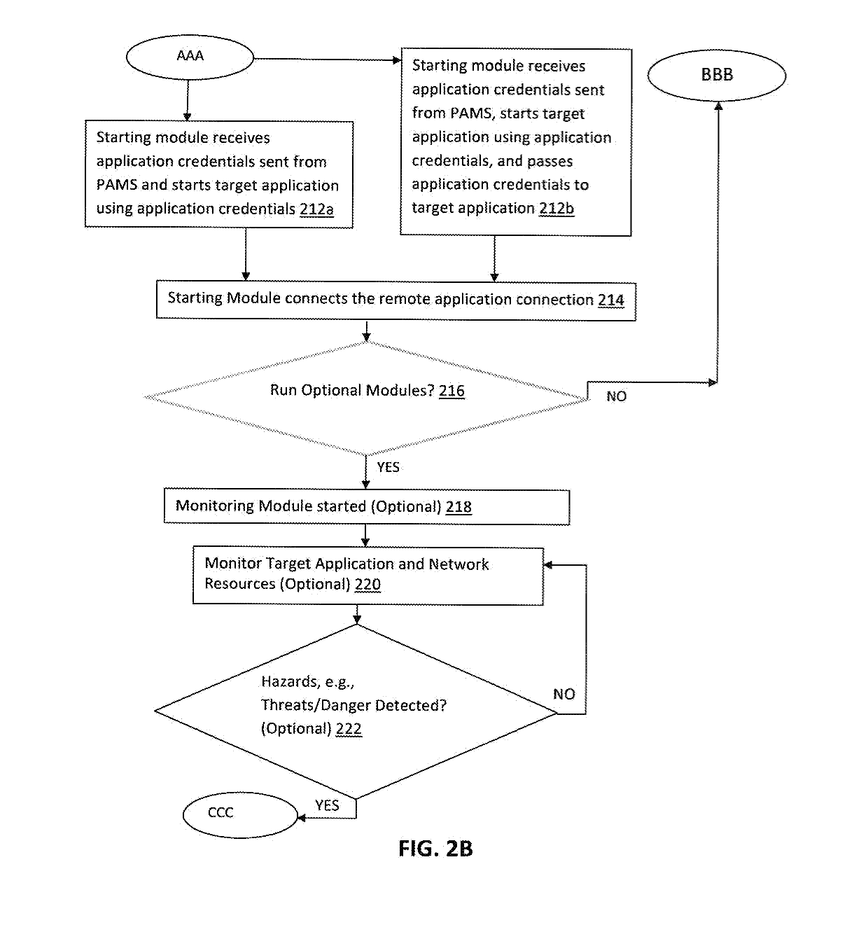

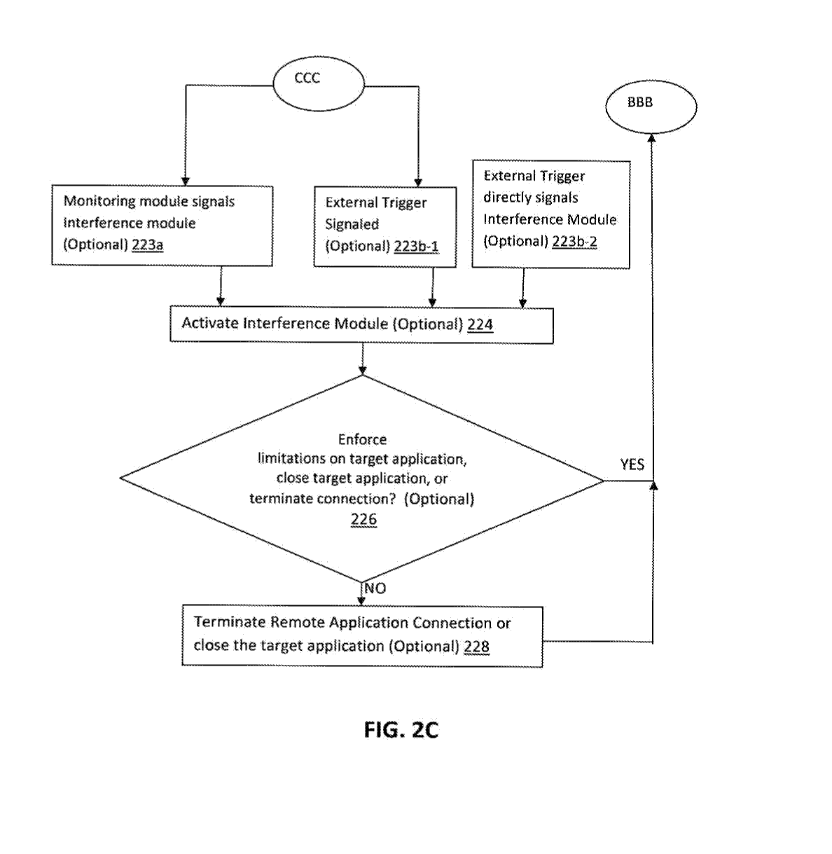

Attention is now directed to FIGS. 2A, 2B and 2C, which form a flow diagram detailing a process in accordance with an embodiment of the disclosed subject matter. Reference is also made to elements shown in FIG. 1. The process and subprocesses of FIGS. 2A, 2B and 2C are a computerized process performed by the server 102, PAMS 106, and the triggering module 32. The server 102 functions as a control system for controlling the modules 104a, 104c, 104d and the target application 104b, as discussed above. The processes and subprocesses of the aforementioned flow diagram are, for example, performed automatically and in real time.

The process of the flow diagram is detailed below for a single occurrence, or single workflow. However, the process is performed multiple times to accommodate multiple users at multiple endpoints, and any number of these multiple processes or workflows may be performed close in time, including simultaneously.

The process starts at block 200, indicated by START. At this time, the user 20, via his computer, e.g., client terminal 31, operating on the endpoint 30, authenticates to PAMS 106 using one set of credentials, known as the user credentials, which are, for example, the personal credentials of the user 20. This first set of credentials, or user credentials identify the user 20 to PAMS 106. A request for access to the target application 104b, using a specific account, is also transmitted to PAMS 106. Either at this time or close in time to the aforementioned sending of the authentication credentials to PAMS 106, the triggering module 32 starts a remote application connection to the target application 104b of the server 102, over the network 50.

The process now moves to both of blocks 202a and 202b, which occur either in parallel or close in time to each other. At block 202a, PAMS 106 receives the user credentials and the request for access to the target application 104b. At block 202b, the server 102 in FIG. 1 or the proxy server 302, in FIG. 3, receives a request to initiate a remote application connection, from the client terminal 31 at the endpoint 30, for example, from the computer of the user 20, over the network 50.

From block 202a, the process moves to block 204, where PAMS 106 determines the authenticity of the user credentials. Should the authentication fail, the process moves to, and ends at block 206, as the user 20, via his client terminal 31, is denied access to the target application 104b. Should the user credentials be authentic, the process moves to block 208, where PAMS 106 verifies that the user 20 has permissions to the target application 104b. Should there not be permissions to the target application for the user 20, the process moves to block 206, where it ends. Otherwise, PAMS 106 provides application credentials to the starting module 104a, at block 210. As stated above, these application credentials are a second set of credentials, completely different than the user credentials, and are completely unknown to the user 20, as this second set of credentials never passes through the endpoint 30. The process moves to block 211. At this block, a request has now been received, and is in existence, to initiate and start the target application connection from the user computer, e.g., client terminal 31, from block 202b, and this existing request, coupled with a proper second set or applications credentials has been received from PAMS 106.

The process now moves to one of blocks 212a or 212b, where the starting module 104a receives the application credentials. The starting module 104a will use these credentials to either: 1) start the target application 104b using the application credentials, at block 212a, or 2) starts the target application and passes the application credentials to the target application 104b, at block 212b. Either of the aforementioned actions starts execution of the target application 104b in the privileged context, for example, such as with starting the PuTTY application passing to it as parameters the credentials for the “root” account of a target server. From either block 212a, or 212b, the process moves to block 214.

The starting module 104a, at block 214, connects the remote application connection, from the client terminal 31 at the endpoint 30 to the target application of the server 102, over the network 50. The user 20 may now work on the target application 104b and access the network resource 110 associated with the target application 104b.

The process moves to block 216, where it is determined if optional modules are to be run, at blocks 218 to 228. If the optional modules are not run, the process moves to block 206, where it ends, for example, by the connection to the application being terminated, by either the user, or a timeout. With the optional modules run, the process moves to block 218. It should be noted that any or all of the optional processes of blocks 218 to 228 may be performed, with the process moving to block 206 and ending after the last optional process is performed.

The process is now at block 218, where the starting module 104a starts the monitoring module 104c. The target application, and the network resource 110, for example, activity associated therewith, is monitored, at block 220. The monitoring is to record the activity and to detect hazards, such as threats, dangers and other occurrences, which may be harmful to the target application, the network resource(s) 110 associated therewith, enterprise's network, machines, computer systems and the like. The monitoring may be continuous, or at intervals, both regular, random and combinations thereof.

The determination of hazards, such as threats and dangers is made at block 222. The detected activity from the aforementioned monitoring can be analyzed by the monitoring module 104c itself, according to a preconfigured logic, or by an external source (external trigger 108) which receives the monitoring. This external source or external trigger 108, collects information about the activity in the network, detects anomalous behavior, and alerts on potential security incidents. In this implementation, the Privileged Threat Analytics can signal the interference module. Should a threat or danger not be detected, the process returns to block 220. As stated above, a signal to the external trigger 108 can also come from a human operator, such as a member of a CIRT (Computer Incident Response Team), who upon a detection of an anomaly in the network or according to some other logic, signals the interference module 104d.

Alternately, should a hazard, such as a threat or danger be detected at block 222, the monitoring module 104 signals the interference module 223a or an external trigger 108 is signaled at block 223b-1. Alternately, an external trigger, from either external trigger 108 or sent manually to the interference module 104d, can directly signal the interference module 104d, at block 223b-2. From either of blocks 223a, 223b-1 or 223b-2, the process moves to block 224, where the interference module 104d is signaled to activate the interference module 104d. The interference module 104d then enforces limitations on commands sent to the target application 104b, closes the target application 104b, or terminates the connection to the target application 104b, at block 226. The limitations, as detailed above, may be on any one of three levels, depending on the limiting selected by the logic of the interference module 104d. These limitations, for example, may be performed on three levels, with a limitation performed on one or several of: 1) the target application level, 2) the communication protocol level, and, 3) the operating system or machine level. With limitations enforced, the process moves to block 206, where it ends.

Returning to block 226, should limitations not be enforced, the process moves to block 228, where other interference action is taken. The interference action taken potentially includes one or both of terminating the remote application connection or closing the target application. With one or both of the aforementioned interference actions taken by the interference module 104d, the process moves to block 206, where it ends.

FIG. 3 shows an operating environment for an application server 301 and a proxy server 302, which defines a non-limiting exemplary control system, the servers 301, 302 defining a computer system, in accordance with some alternative embodiments of the present invention. The application server 301 hosts the target application 104b, which is shown in FIG. 1 and detailed above. The proxy server 302 includes, for example, the starting module 104a, monitoring module 104c, and interference module 104d, all shown in FIG. 1 and detailed above. The application server 301 and proxy server 302 are linked to each other, as illustrated by the double headed arrow, and linked to the network 50.

PAMS 106 and the network resource 110 are in accordance with that shown in FIG. 1 and detailed above. PAMS 106 links to the proxy server 302, as shown by the double headed arrow. Similarly, the user 20, endpoint 30, client terminal 31, and triggering module 32 are in accordance with that shown in FIG. 1 and detailed above.

The system of the application server 301, proxy server 302, PAMS 106 and triggering module 32 function similarly to the system of server 102, PAMS 106 and triggering module 32, in that the proxy server 302 functions similarly to server 102 in FIG. 1, the only difference being that in FIG. 3 the starting module 104a starts a remote application 104b on the application server 301, while in FIG. 1 the starting module 104a starts a local application on server 102. All other functionality is the same—the starting module 104a passes the remote connection from client terminal 31 to the target application 104b, and optional modules 104c and 104d operate the same as in FIG. 1. In essence, the only difference is whether the target application 104b is a local application or remote application, from the point-of-view of starting module 104a. The application server 301, proxy server 302 and PAMS 106 function in accordance with the processes detailed above as illustrated in the flow diagrams of FIGS. 2A to 2C, except where specifically indicated.

Alternative embodiments are such that a workflow is established where the second set of credentials used to run the target application is provided by the user 20. These embodiments are particularly useful, for example, when the PAMS 106 does not yet have the required credentials for the target application 104b. In this case, the first set of credentials is supplied by the user 20 to authenticate to PAMS 106 and a second set of credentials is supplied by the user 20 to start or pass to the target application 104b. This setup still benefits from the monitoring and interference capabilities in protecting the target application 104b, as described above.

### EXAMPLES

### Example 1

### Shared Privilege Credentials

A system administrator wants to establish a connection as a “root” account to a target Unix machine using the PuTTY application. The “root” account is a sensitive account, as it has high permissions on the target system. It is highly controlled by the enterprise, which places strict controls over the connection, and the enterprise deems the PuTTY application to be sensitive when used with a privileged account, such as a “root” account.

The system administrator authenticates from his endpoint to PAMS, using his personal organizational account, and requests to start the sensitive application with the specific “root” account relevant to the target system. PAMS verifies that the administrator has access rights to the sensitive application with the account that the administrator requested. If access is verified, the sensitive PuTTY application is started on the remote server with the target system credentials, and the system administrator has a remote application connection open on his endpoint.

By employing this system, these “root” account credentials are not divulged to the administrator and never reach his endpoint. All actions are also monitored and can be attributed to the specific user.

### Example 2

### Sensitive Business Application

A bank employee with access to a sensitive wire-transfer system needs to perform a wire-transfer order through a proprietary application. The bank considers orders for this wire-transfer system sensitive and protects the access by employing the described invention.

The bank employee authenticates to the PAMS system and following the process described above in FIGS. 2A to 2C, a remote application connection is established to the proprietary wire-transfer application. All the activity is monitored and additional limits can be enforced on the connection through the interference module—for example, preventing specific commands or even terminating the session if unwarranted activity is detected.

As a result of this disclosed subject matter, the sensitive credentials required to operate the wire-transfer application are not divulged to the bank employee and never reach his endpoint. Therefore, they cannot be stolen by malware and significantly increase the security of the bank's operation. Accordingly, the potential for criminal acts via hacking methods, such as phishing, drive-by exploit and others to install malware on bank employee machines and steal their credentials, to access accounts and funds therein, is eliminated.

### Example 3

### Critical Infrastructure

A power utility operator working in the control room needs to monitor and operate a sensitive application which controls an aspect of the critical infrastructure, such as power transmission. This work is often performed in shifts, with employees working in their assigned roles (“Operator 1”, “Operator 2”, “Supervisor” and so on). Each role is assigned shared credentials, which the operators use to login to the application. This usually creates an accountability and attribution challenge, as several employees use the same credentials and it is difficult to know who performed what action in the sensitive application.

With the system of the disclosed subject matter, the operator connects to PAMS using his personal credentials, and then operates in a remote application session. While the user experience remains the same, all activity in the sensitive application can now be logged and monitored, and the actions performed in this session can now be attributed to the specific operator.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant remote applications and remote application connections will be developed and the scope of the terms remote applications and remote application connections is intended to include all such new technologies a priori.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments.” Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A computer-implemented method performed by a computer system for controlling use of applications, accessible via a network, comprising:
receiving, by a credentialing system, a first set of user credentials from a client terminal at a first network node, via said network, said first set of user credentials included as part of an access request to a target application, said target application hosted and controlled by a computer system at a different network node;
authenticating, by said credentialing system, said first set of user credentials;
upon a successful authentication of said first set of user credentials, providing, by said credentialing system, to said computer system, a second set of application credentials for granting access to said target application on said computer system;
wherein upon receiving said second set of application credentials from said credentialing system, said computer system executes said target application using said second set of application credentials;
wherein upon said execution of said target application, said computer system establishes said remote application connection initiated by said request to initiate said remote application connection, with said executing target application such that a user of said client terminal is allowed access to said target application;
wherein at said first network node, the user experience of interaction with said target application is similar to that of a locally running application, as a desktop application of said client terminal connects via said remote application connection to said target application executing remotely at said computer system, and
wherein said second set of application credentials are different from said first set of user credentials.

2. The method of claim 1, wherein said computer system includes a server which hosts said target application and at least one module for starting execution of said target application, said server at a second network node.

3. The method of claim 1, wherein said computer system includes a first server which hosts said target application, at a second network node, and a second server which hosts at least one module for starting execution of said target application, said second server at a third network node.

4. The method of claim 1, wherein said execution of said target application includes a starting module of said computer system executing said target application.

5. The method of claim 4, wherein said starting module executes said target application using said second set of credentials.

6. The method of claim 5, wherein said starting module executes said target application and passes said second set of credentials to said target application.

7. The method of claim 1, wherein said target application is associated with a network resource linked to said network.

8. The method of claim 1, wherein said connecting of said remote application connection begins a target application session, and additionally comprising: monitoring said target application session by monitoring at least one of: said target application, a network resource associated therewith, the system hosting said target application, a communications network of an enterprise associated with said target application, and a communications network of an enterprise associated with a network resource associated with said target application.

9. The method of claim 8, wherein said monitoring is selected from the group consisting of video monitoring, real-time monitoring, over the shoulder monitoring, and command level auditing.

10. The method of claim 8, wherein said monitoring includes detecting hazards to at least one of, said target application, said network resource associated therewith, said system hosting said target application, said communications network of said enterprise associated with said target application, and said communications network of said enterprise associated with said network resource associated with said target application.

11. The method of claim 10, wherein an interference action is taken in response to at least one of said hazards being detected.

12. The method of claim 11, wherein said interference action is selected from the group consisting of sending limiting commands to said target application, terminating said remote application connection, and closing said target application.

13. The method of claim 1, wherein an interference action is taken in response to at least one external trigger.

14. The method of claim 13, wherein said interference action is selected from the group consisting of sending limiting commands to said target application, terminating said remote application connection, and closing said target application.

15. The method of claim 1, wherein said second set of application credentials does not pass through said first network node.

16. The method of claim 1, wherein said connecting, by said computer system, of said remote application connection with said executing target application is performed automatically.

17. A computerized system for controlling use of applications, accessible via a network, comprising:
a credentialing system in communication with a computer system, said credentialing system comprising:
a processor;
a non-transitory computer readable medium comprising computer executable instructions executable by said processor, comprising:
a first set of instructions for receiving a first set of user credentials from a client terminal at a first network node, via said network, said first set of user credentials included as part of an access request to a target application, a second set of instructions for authenticating said first set of user credentials; and a third set of instructions for issuing upon a successful authentication of said first set of user credentials, a second set of application credentials for granting access to said target application on a computer system which hosts and controls said target application;
wherein a starting module installed on a computer system hosting and controlling a target application at a different at least one network node, comprising instructions for receiving the second set of application credentials from said credentialing system, instructions for executing of said target application using said second set of application credentials upon receiving said second set of application credentials from said credentialing system, and instructions for establishing a remote application connection between said client terminal and said target application such that a user of said client terminal is allowed access to said target application; and,
a triggering module associated with said client terminal at said first network node, said triggering module comprising instructions for issuing requests to said computer system to initiate remote application connections to said target application;
wherein at said first network node, the user experience of interaction with said target application is similar to that of a locally running application, as a desktop application of said client terminal connects via said remote application connection to said target application executing remotely at said computer system, and,
wherein said second set of application credentials are different from said first set of user credentials.

18. The computerized system of claim 17, wherein said computer system includes a server which hosts said target application and said starting module, said server at a second network node.

19. The computerized system of claim 17, wherein said computer system includes a first server which hosts said target application, at a second network node, and a second server which hosts said starting module, said second server at a third network node.

20. The computerized system of claim 17, wherein said starting module additionally passes said second set of credentials to said target application after executing said target application.

21. The computerized system of claim 17, wherein said target application is associated with a network resource linked to said network.

22. The computerized system of claim 21, wherein said computer system additionally comprises a monitoring module comprising instructions for monitoring at least one of: said target application, a network resource associated therewith, said system hosting said target application, a communications network of an enterprise associated with said target application, and a communications network of an enterprise associated with a network resource associated with said target application.

23. The computerized system of claim 22, wherein said monitoring module comprises instructions for performing monitoring by at least one of the group consisting of, video monitoring, real-time monitoring, over the shoulder monitoring, and command level auditing.

24. The computerized system of claim 22, wherein said monitoring module comprises instructions for detecting hazards to at least one of, said target application, said network resource associated therewith, said system hosting said target application, said communications network of said enterprise associated with said target application, and said communications network of said enterprise associated with said network resource associated with said target application.

25. The computerized system of claim 22, wherein said computer system additionally comprises an interference module comprising instructions for taking an interference action in response to at least one of said hazards being detected, said interference actions is selected from the group consisting of sending limiting commands to said target application, terminating said remote application connection, and closing said target application.

26. The computerized system of claim 25, additionally comprising an external trigger module linked to said network for communicating with said interference module, said external trigger module comprising instructions for activating said interference module to take said interference action.

27. A computer program product comprising a readable non-transitory storage medium storing program code thereon for use by a programmed credentialing system for controlling use of applications, accessible via a network, said program code comprising:
instructions to receive a first set of user credentials from a client terminal at a first network node, via a network, said first set of user credential included as part of an access request to a target application;
instructions to authenticate said first set of user credentials;
instructions to provide, upon a successful authentication of said first set of user credentials, to a computer system hosting and controlling said target application at a first network node, a second set of application credentials for granting access to said target application on said computer system;
wherein upon receiving said second set of application credentials from said credentialing system, said computer system executes said target application using said set of application credentials; and
wherein upon said execution of said target application, said computer system establishes said remote application connection initiated by said request to initiate said remote application connection, with said executing target application such that a user of said client terminal is allowed access to said target application;
wherein said second set of application credentials are different from a first set of user credentials.

28. The computer usable non-transitory storage medium of claim 27, wherein said step of connecting of said remote application connection begins a target application session, and said steps additionally comprise: monitoring said target application session by monitoring at least one of: said target application, a network resource associated therewith, said system hosting said target application, a communications network of an enterprise associated with said target application, and a communications network of an enterprise associated with a network resource associated with said target application.

29. The computer usable non-transitory storage medium of claim 28, wherein said monitoring is selected from the group consisting of video monitoring, real-time monitoring, over the shoulder monitoring, and command level auditing.

30. The computer usable non-transitory storage medium of claim 29, wherein said monitoring includes detecting hazards to at least one of, said target application, said network resource associated therewith, said system hosting said target application, said communications network of said enterprise associated with said target application, and said communications network of said enterprise associated with said network resource associated with said target application.

31. The computer usable non-transitory storage medium of claim 30, wherein said steps additionally comprise: taking an interference action in response to at least one of said hazards being detected.

32. The computer usable non-transitory storage medium of claim 31, wherein said interference action is selected from the group consisting of sending limiting commands to said target application, terminating said remote application connection, and closing said target application.

33. The computer usable non-transitory storage medium method of claim 27, wherein said steps additionally comprising taking an interference action in response to at least one external trigger.

34. The computer usable non-transitory storage medium of claim 33, wherein said interference action is selected from the group consisting of sending limiting commands to said target application, terminating said remote application connection, and closing said target application.

35. The method of claim 1, wherein said second set of application credentials are at least one of not known and not divulged, to said user.
